(19) United States
(12) Patent Application Publication
(10) Pub. No.: US 2008/0254767 A1
(43) Pub. Date: Oct. 16, 2008

(54) System and method for limiting access to features in a mobile telecommunications device

(75) Inventor: Hong Jin, Vancouver, WA (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 11/786,094

(22) Filed: Apr. 10, 2007

(51) Int. Cl. H04M 1/66

(52) U.S. Cl. 455/411

(57) ABSTRACT

A mobile telecommunications device with a processor, memory in electronic communication with the processor, and instructions stored in the memory, the instructions being executable to implement a method for childproof operation wherein the user's access is limited to a subset of applications and services while the device is in childproof mode. A preferred embodiment includes providing a default set of applications and services to enable while in childproof mode and allowing the user to individually specify the applications and services to enable while in childproof mode.

### BACKGROUND OF THE INVENTION

1. Field of the Invention

The present invention relates generally to the field of telecommunications. In particular, this invention relates to a system and method for limiting access to features in a mobile telecommunications device.

2. Description of the Related Art

Parents have come to appreciate the efficacy with which cellular phonebased video games can occupy otherwise unruly children. It is common to see parents handing cellular phones to youngsters while seated in restaurants, churches, cars, etc. with the understanding that the child will remain occupied while playing a video game or otherwise using the device in a benign manner.

As wireless carriers and cellular phone manufacturers have added more and more revenue-generating services to handsets, more opportunities exist for users to unintentionally access services that then result in unexpected fees. This problem is especially acute for children who may unintentionally (or in the case of downloading video games, perhaps intentionally) access fee based services without the knowledge or consent of the adult who unwittingly provided the cellular phone with the expectation that the child would limit his or her actions to playing an already present video game.

Another issue is related to data security. Although virtually all cellular phones have a facility for storing frequently dialed numbers, more advanced models offer significantly more powerful information management features on par with a PDA, or in some cases a laptop computer. Such so-called smart phones may also offer realtime connectivity to personal information that is stored on a network-connected file server. With lightly supervised usage (such as that which occurs when an adult hands a child a phone with which to play video games) all of this data becomes vulnerable to unintentional deletion or corruption.

Consequently, what is needed is a simplified technique for permitting an individual to use a handset to execute stored applications, use a camera, or view content while at the same time preventing access to other cellular phone and network features.

### BRIEF SUMMARY OF THE INVENTION

The present invention provides a mode that permits individuals to use a handset to execute stored applications, use a camera, or view content while at the same time preventing access to other handset features.

In an embodiment of the present invention, a mobile telecommunication device includes: a processor, memory coupled to the processor, wherein instructions are stored in the memory, and are executable to implement a method for childproof operation of said mobile telecommunications device thus enabling a childproof mode which restricts a user's access to a subset of applications and services.

This embodiment also provides a system that allows for childproof operation of a mobile telecommunications device wherein the system includes: a wireless network for providing coupling between the mobile telecommunications device, other wireless devices and a public switched telephone network (PSTN). In such case, the mobile telecommunications device includes a processor, memory coupled to the processor, wherein instructions are stored in the memory and are able to implement a method for childproof operation of said mobile telecommunications device thus enabling childproof mode which restricts a user's access to a subset of applications and services.

### BRIEF DESCRIPTION OF THE DRAWINGS

The present invention is illustrated by way of example and not by limitation in the accompanying figures in which like reference numerals indicate similar elements and in which:

FIG. 1 depicts a functional block diagram of a mobile camera telephone that is suitable for use with the present invention; and

FIG. 2 depicts a user interface for a first exemplary embodiment of a method for selectively enabling a subset of features; and

FIG. 3 depicts a flow diagram for a first exemplary embodiment of a method for limiting access to features in a mobile telecommunications device according to the present invention.

### DETAILED DESCRIPTION OF THE INVENTION

A mobile telecommunications device such as, for example, a cellular phone, is disclosed comprising a processor and memory coupled to a processor. Instructions are stored in the memory and are executable to implement a method for childproof operation of the mobile telecommunications device which allows a user to enable childproof mode and restricts the user's access to a subset of applications and services (such as, for example, a phonebook, voice calling, text messaging, multimedia messaging, email, image capture, games, applications and settings).

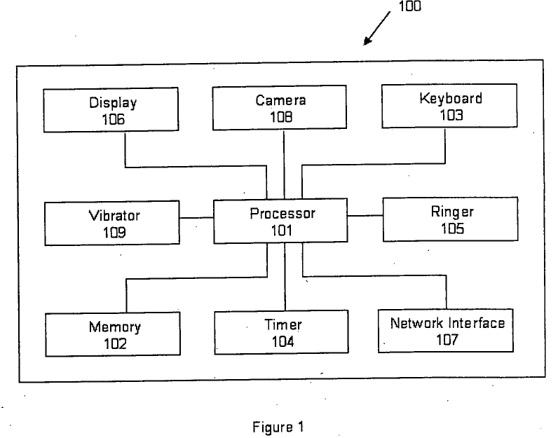

FIG. 1 depicts a functional block diagram at a mobile camera telephone that is suitable for use with the present invention. Mobile camera telephone 100 includes a processor 101, memory 102, a keyboard 103, a timer 104, a ringer 105, a display 106, a network interface 107, a camera 108 and a vibrator 109. Memory 102 stores information, such as, but not limited to instructions, programs and applications that are executable by processor 101, configuration information, a phonebook and a gallery of photographs. Keyboard 103 can be used for entering a dialed number, configuration information and text information forming a message. Display 106 displays information and provides a visual interface for a user of the mobile camera telephone. Network interface 107 provides a wireless interface in a well-known manner to a communications network, such as a cellular network or a personal communication system (PCS) network. Camera 108 provides cameratype functionality in a well-known manner. Vibrator 109 provides tactile alerts and indications to the user in a well-known manner.

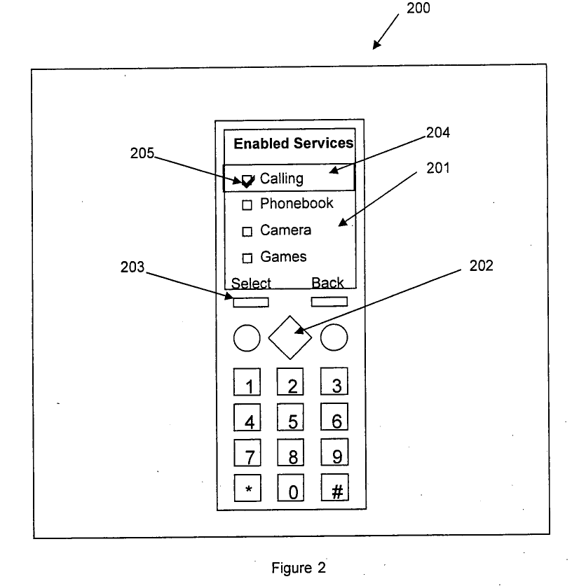

FIG. 2 depicts a mobile camera telephone that is suitable for use with the present invention. Mobile camera telephone 200 includes a display 201, navigation key 202, select key 203, highlighted screen region 204 and checkbox 205. Navigation key 202 can be used in a well-known manner to move the highlighted screen region 204 up or down. Select key 203 toggles the state of the checkbox 205 within the highlighted screen region 204 to indicate which services are to be enabled during childproof mode.

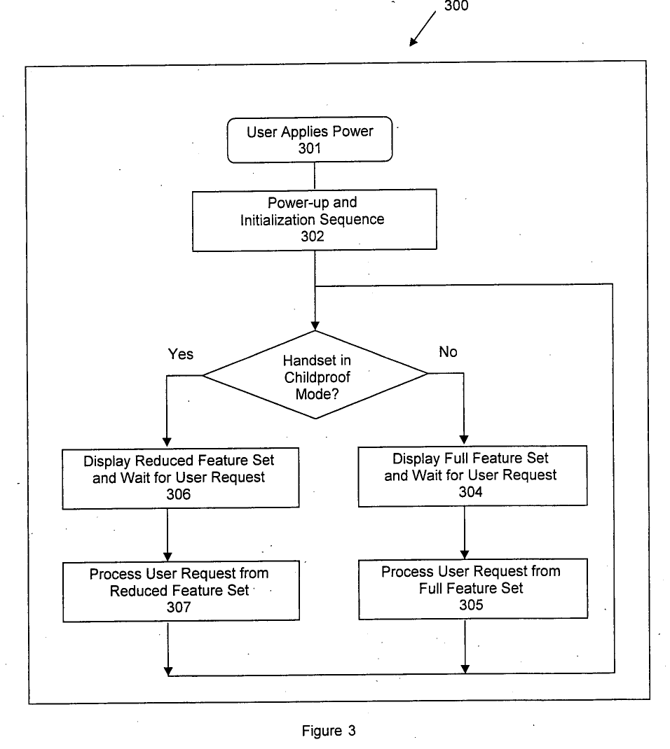

FIG. 3 depicts a flow diagram 300 for a first exemplary embodiment of a method for childproof operation of a mobile telecommunications device according to the present invention. At step 301, a user of a mobile telecommunications device turns on the device. This causes device initialization to occur in step 302. At step 303, the device checks the childproof mode setting. If childproof mode is disabled, the device displays the full feature set to the user in step 304 and upon a request from the user, executes the request in step 305. One possible request in step 304 would be to enable childproof mode. Upon processing the request in 305, step 303 checks the status of childproof mode and transitions to step 304 or step 306 accordingly. If childproof mode is enabled, then step 303 will transition to step 306, where a reduced feature set will be displayed. At step 307 a request from the reduced feature set is processed. One possible request at step 306 would be to disable childproof made. Upon processing of the request in step 307, step 303 checks the status of childproof mode and transitions to step 304 or 306 accordingly.

The mobile telecommunications device may be a cellular telephone and may include applications and services. These applications and services may be, but are not limited to any of the following: a phonebook, voice calling, text messaging, multimedia messaging, email, image capture, games, applications and settings.

The user may select the criteria for enabling and disabling childproof mode. Criteria may include but is not limited to a entry of a password, biometric data or a gesture.

Childproof mode is intended to provide access to a limited subset of functions such as video games while simultaneously restricting access to features such as voice calling so as to prevent unintended operations. For many users, it would be adequate to simply enable game playing and prevent all other features. Therefore the method implemented by the executable instructions further comprises providing a default set of applications and services to enable while in childproof mode.

However for other users, it may be desirable to individually select the specific applications and services to make available. Therefore the method implemented by the executable instructions further comprises allowing the user to select the subset of applications and services to enable while in childproof mode.

In most cases, it is anticipated that the subset of features permitted in childproof mode will be small. However, in some circumstances, only a few features or services will need to be disabled in childproof mode (for an older child, perhaps blocking only the downloading of premium content is necessary) and in this case, it is desirable to allow the user to select only those features that are to be blocked. Therefore, the method implemented by the executable instructions further comprises allowing the user to define the subset of applications and services to disable while in childproof mode. And, to make handset setup easier, the method implemented by the executable instructions further comprises providing a default set of applications and services to disable while in childproof mode.

While the telecommunication device is in childproof mode, the handset owner may not be nearby or free to take calls. Therefore, the method implemented by the executable instructions further comprises forwarding incoming calls while in childproof mode. This has the added benefit of not interrupting game play. However, it is also possible that the handset owner is nearby and wishes to take calls. In this case, it may take a few extra moments to retrieve the handset in order to answer the call. In most cellular phone networks, calls are forwarded or transferred to a voicemail system after a predetermined ringing time. In order to satisfy the need for a few extra moments to retrieve the handset from a child who may be actively engaged in playing a video game, the method implemented by the executable instructions further comprises waiting an additional time period before forwarding an unanswered call that arrives while in childproof mode.

Modern cellular handsets provide a facility to display the phone number of the incoming caller. However, this is of little use if the handset has been placed in childproof mode and is nearby but not in the owner's immediate possession. Moreover, the owner may not wish to retrieve the handset from the child each time the handset rings. For this reason, the method implemented by he executable instructions further comprises the option of selectively enabling an audible indication of information related to the identity of the caller. After hearing this information, the handset owner could decide whether or not to take the call.

A system for providing childproof operation of a mobile telecommunication device is also disclosed. The system comprising a wireless network providing connectivity between the mobile telecommunication device and other wireless devices and the public switched telephone network, a plurality of subscribers to the wireless network and public switched telephone network and a mobile telecommunication device comprising a processor, memory in electronic communication with the processor and instructions stored in the memory, the instructions being able to implement a method for childproof operation of said mobile telecommunications device comprising allowing the user to enable childproof mode, restricting the user's access to a subset of applications and services while the device is in childproof mode, and allowing the user to disable childproof mode.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A mobile telecommunications device comprising: a processor; memory in electronic communication with the processor; and instructions stored in the memory, the instructions being executable to implement a method for child proof operation of said mobile telecommunications device comprising: allowing the user to enable childproof mode;
restricting the user's access to a subset of applications and services while the device is in childproof mode; and allowing the user to disable childproof mode.

2. The mobile telecommunications device as claimed in claim 1 wherein said mobile telecommunication device comprises a cellular telephone.

3. A mobile telecommunications device as claimed in claim 1 wherein said applications and services comprise phonebook, voice calling, text messaging, multimedia messaging, email, image capture games and applications.

4. A mobile telecommunications device as claimed in claim 1 wherein said method implemented by the executable instructions further comprises allowing the user to select the criteria for enabling childproof mode.

5. A mobile telecommunications device as claimed in claim 1 wherein said method implemented by the executable instructions further comprises allowing the user to select criteria for disabling childproof mode.

6. A mobile telecommunications device as claimed in claim 1 wherein said method implemented by the executable instructions further comprises providing a default set of applications and services to enable while in childproof mode.

7. A mobile telecommunications device as claimed in claim 6 wherein said method implemented by the executable instructions further comprises allowing the user to select the subset of applications and services to enable while in childproof mode.

8. A mobile telecommunications device as claimed in claim 1 wherein said method implemented by the executable instructions further comprises providing a default set of applications and services to disable while in childproof mode.

9. A mobile telecommunications device as claimed in claim 8 wherein said method implemented by the executable instructions further comprises allowing the user to define the subset of applications and services to disable while in childproof mode.

10. A mobile telecommunications device as claimed in claim 1 wherein said method implemented by the executable instructions further comprises forwarding incoming calls while in childproof mode.

11. A mobile telecommunications device as claimed in claim 10 wherein said method implemented by the executable instructions further comprises waiting an additional time period before forwarding an unanswered call that arrives while in childproof mode.

12. A mobile telecommunications device as claimed in claim 1 wherein said method implemented by the executable instructions further comprises producing an audible indication of information related to caller identity while in childproof mode.

13. A system for providing childproof operation of a mobile telecommunication device, the system comprising:
a wireless network providing connectivity between the mobile telecommunication device and other wireless devices and the public switched telephone network;
a plurality of subscribers to the wireless network and public switched telephone network; and
a mobile telecommunication device comprising:
a processor;
memory in electronic communication with the processor; and
instructions stored in the memory, the instructions being able to implement
a method for childproof operation of said mobile telecommunications device comprising:
allowing the user to enable childproof mode;
restricting the user's access to a subset of applications and services while the device is in childproof mode; and
allowing the user to disable childproof mode.
